(19) United States
(12) Patent Application Publication
(10) Pub. No.: US 2022/0032922 A1
(43) Pub. Date: Feb. 3, 2022

(54) VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventors: Jin Mo Lee, Uiwang-si (KR); Young Bin Min, Busan (KR)

(21) Appl. No.: 17/084,004

(22) Filed: Oct. 29, 2020

(30) Foreign Application Priority Data
Jul. 29, 2020 (KR) 10-2020-0094453

(51) Int. Cl. B60W 40/09; G06K 9/00; G08G 1/0962; B60W 40/04; B60W 40/06; B60W 60/00; B60W 50/16

(52) U.S. Cl. CPC B60W 40/09; B60W 2040/0872; G06K 9/00805; G08G 1/09626; B60W 40/04; B60W 40/06; B60W 60/0015; B60W 50/16; B60W 2520/10; B60W 2540/22; B60W 2554/4029; B60W 2552/00; B60W 2540/221; B60W 2540/229; G06K 9/00845

(57) ABSTRACT

A method of controlling a vehicle includes acquiring biometric data of a user in the vehicle, determining first determination information related to inattention of the user based on the biometric data, acquiring driving related information of the vehicle, determining second determination information related to driving complexity based on the driving related information, and determining whether to provide a feedback function to the user based on the first determination information and the second determination information.

This application claims the benefit of Korean Patent Application No. 10-2020-0094453, filed on Jul. 29, 2020, which is hereby incorporated by reference as if fully set forth herein.

### TECHNICAL FIELD

The present disclosure relates to technology for providing an emotion-recognition-based service in consideration of the attention of a user, and more particularly to a vehicle and a method of controlling the same for overcoming problems due to unnecessary provision of a service by providing an emotion-recognition-based service in an environment in which the attention of the user is not impeded.

### BACKGROUND

Recently, research has been actively conducted into technology for determining the emotional state of a user in a vehicle. In addition, research has also been actively conducted into technology for inducing a positive emotion of a user in a vehicle based on the determined emotional state of the user.

However, conventional emotion-recognition-based services determine only whether the emotional state of a user in a vehicle is positive or negative, and merely provides feedback for adjusting output of components in the vehicle based on whether the determined emotional state is positive or negative.

However, an effect of improving the emotions of a user is largely affected by the driving environment as well as the simple emotional state of the user. For example, when a vehicle travels on a road on which the level of attention needs to be high, even if an emotion-recognition-based service is provided to a user, the emotion improvement effect may be reduced. In contrast, in the case of an autonomous driving state, a relatively high emotion improvement effect may be achieved.

### SUMMARY

Accordingly, the present disclosure is directed to a vehicle and a method of controlling the same for providing an emotion-recognition-based service in consideration of the attention that a user is paying to driving.

In particular, the present disclosure provides a vehicle and a method of controlling the same for improving satisfaction with a service by providing the service in an appropriate situation and at an appropriate time for the emotion-based service in consideration of attention required when the user drives the vehicle as well as the emotional state of the user.

The technical problems solved by the embodiments are not limited to the above technical problems and other technical problems which are not described herein will become apparent to those skilled in the art from the following description.

To achieve these objects and other advantages and in accordance with the purpose of the disclosure, as embodied and broadly described herein, a method of controlling a vehicle includes acquiring biometric data of a user in the vehicle, determining first determination information related to inattention of the user based on the biometric data, acquiring driving related information of the vehicle, determining second determination information related to driving complexity based on the driving related information, and determining whether to provide a feedback function to the user based on the first determination information and the second determination information.

In another aspect of the present disclosure, a vehicle includes a sensor configured to acquire biometric data of a user in the vehicle and driving related information of the vehicle, a feedback output configured to output at least one feedback signal of auditory feedback, visual feedback, temperature feedback, or tactile feedback, which is set depending on an emotional state determined based on the biometric data of the user, and a controller configured to determine first determination information related to inattention of the user based on the biometric data, to determine second determination information related to driving complexity based on the driving related information, and to perform control to determine whether the feedback output is operated based on the first determination information and the second determination information.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a control block diagram of a vehicle according to an embodiment of the present disclosure;

FIG. 2 is a diagram showing the relationship between a sensing signal and an acquired signal according to an embodiment of the present disclosure;

FIG. 3 is a block diagram showing the configuration for calculation of an index of necessity of attention according to an embodiment of the present disclosure;

FIG. 4 is a diagram for explaining a method of calculating an index of necessity of attention according to an embodiment of the present disclosure;

FIG. 5 is a diagram showing the configuration of a feedback output according to an embodiment of the present disclosure;

FIGS. 6 and 7 are diagrams for explaining a method of providing an emotion-based service based on an index of necessity of attention according to the present disclosure; and

FIG. 8 is a control flowchart of a vehicle according to an embodiment of the present disclosure.

### DETAILED DESCRIPTION

Exemplary embodiments of the present disclosure are described in detail so as for those of ordinary skill in the art to easily implement the present disclosure with reference to the accompanying drawings. However, the present disclosure may be implemented in various different forms and is not limited to these embodiments. To clearly describe the present disclosure, a part without concerning to the description is omitted in the drawings, and like reference numerals in the specification denote like elements.

Throughout the specification, one of ordinary skill would understand terms “include”, “comprise”, and “have” to be interpreted by default as inclusive or open rather than exclusive or closed unless expressly defined to the contrary. Further, terms such as “unit”, “module”, etc. disclosed in the specification mean units for processing at least one function or operation, which may be implemented by hardware, software, or a combination thereof.

The present disclosure may provide a vehicle and a method of controlling the same for improving user satisfaction with an emotion-based service by providing the emotion-based service in an appropriate situation and at an appropriate time for the service in consideration of both the emotional state and the attention that the user is paying to driving.

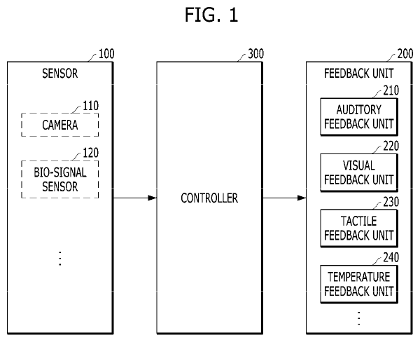

FIG. 1 is a control block diagram of a vehicle according to an embodiment of the present disclosure.

Referring to FIG. 1, the vehicle according to an embodiment of the present disclosure may include a sensor 100 for acquiring state information of a user and driving state information and outputting a sensing signal, a controller 300 for determining whether feedback is output based on the sensing signal, and a feedback output 200 for outputting feedback for inducing a target emotion in the user under the control of the controller 300.

The sensor 100 may include a camera 110 for acquiring image data and a bio-signal sensor 120 for measuring the sensing signal of the user in the vehicle.

The camera 110 may include an internal camera, which is installed inside the vehicle and acquires image data of the user in the vehicle, and an external camera, which is installed outside the vehicle and acquires image data of the external situation. The camera 110 is not limited as to the installation position or number thereof, and may also include an infrared camera for photography when the vehicle travels at night.

The bio-signal sensor 120 may measure a bio-signal of the user in the vehicle. The bio-signal sensor 120 may be installed at various positions in the vehicle. For example, the bio-signal sensor 120 may be provided in a seat, a seat belt, a steering wheel, a knob of a door, or the like. The bio-signal sensor 120 may also be provided as a type of a wearable device that is wearable by the user in the user. The bio-signal sensor 120 may include at least one of an electrodermal activity (EDA) sensor for measuring the electrical characteristics of the skin, which are changed depending on the amount that the user is sweating, a skin temperature sensor for measuring the temperature of the skin of the user, a heartbeat sensor for measuring the heart rate of the user, a brainwave sensor for measuring a brainwave of the user, a voice recognition sensor for measuring a voice signal of the user, a blood-pressure-measuring sensor for measuring the blood pressure of the user, or an eye tracker for tracking the position of the pupil. The sensors included in the bio-signal sensor 120 are not limited thereto, and may include any sensor for measuring or collecting a bio-signal of a human.

The feedback output 200 may include at least one of an auditory feedback output 210, a visual feedback output 220, a tactile feedback output 230, or a temperature feedback output 240. The feedback output 200 may provide output for improving the emotional state of the user under the control of the controller 300. For example, the auditory feedback output 210 may provide an auditory signal for improving the emotional state of the user, the visual feedback output 220 may provide a visual signal for improving the emotional state of the user, the tactile feedback output 230 may provide a tactile signal for improving the emotional state of the user, and the temperature feedback output 240 may provide a temperature for improving the emotional state of the user.

The controller 300 may calculate the emotional state of the user and an index of necessity of driving concentration based on the sensing signal input by the sensor 100, and may control the feedback output 200 according to the calculation result. The controller 300 may determine whether the emotional state of the user is a state in which a specific emotion occurs or stress of a threshold value or greater occurs, in which case an emotion-recognition-based service is required. Upon determining that the emotion-recognition-based service is required, the controller 300 may calculate an index of necessity of attention based on the state information and the driving state information of the user. When determining that the state in which the index of necessity of driving concentration is equal to or less than a reference value is maintained for a reference time, the controller 300 may control the feedback output 200 to provide the emotion-recognition-based service. In contrast, when the state in which the index of necessity of driving concentration is greater than the reference value or is equal to or less than the reference value is not maintained up to the end of the reference time, the controller 300 may control the feedback output 200 not to provide the emotion-recognition-based service.

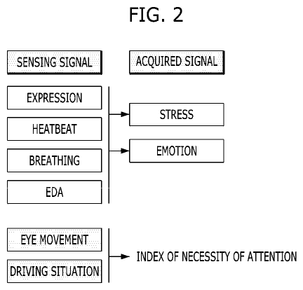

FIG. 2 is a diagram showing the relationship between a sensing signal and an acquired signal according to an embodiment of the present disclosure. The controller 300 may acquire signals required to calculate the emotional state of a user and an index of necessity of attention, such as a stress signal, an emotion signal, or an index of necessity of attention, based on the sensing signal received from the sensor 100.

The sensing signal may include an expression-sensing signal acquired as the result of recognition of a facial expression of a face image of the user, acquired by the camera 110, and a heartbeat-sensing signal, a breathing-sensing signal, and an electrodermal activity (EDA)-sensing signal, which are sensed through the bio-signal sensor 120.

The stress level and the emotional state of the user may be acquired from sensed signals related to the state of the user, such as an expression-sensing signal, a heartbeat-sensing signal, a breathing-sensing signal, or an EDA-sensing signal. For example, in the case of an expression-sensing signal, expression may be recognized and may be output as the expression-sensing signal using a method of detecting features by modeling the intensity of a pixel value from a face image of the user, acquired by the camera 110, or a method of detecting a feature by searching for the geometrical arrangement of feature points in the face image. Whether the current state is a stressed state may be determined, or the emotional state may be determined, via comparison by comparing preset values with measured values for the heartbeat-sensing signal, the breathing-sensing signal, and the EDA-sensing signal. In the case of a conventional emotion-based service, when it is determined that the emotional state of the user is the state in which a specific emotion occurs or stress of a threshold value or greater occurs, the service is provided through a feedback output.

In contrast, according to an embodiment of the present disclosure, even if it is determined that the emotional state of the user is the state in which a specific emotion occurs or stress of a threshold value or greater occurs, whether to provide the service may be determined by calculating an index of necessity of attention required for driving from eye movement of the user, sensed through an eye tracker, and information on a driving situation, acquired through an external camera.

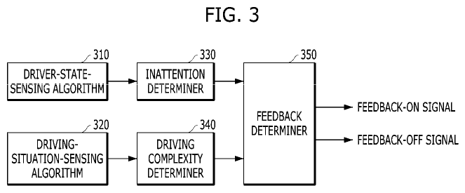

FIG. 3 is a block diagram showing the configuration for calculation of an index of necessity of attention according to an embodiment of the present disclosure.

Referring to FIG. 3, a vehicle according to an embodiment of the present disclosure may include a driver-state-sensing algorithm 310 (in one example, the element 310 may refer to a hardware device such as a circuit or a processor configured to execute the driver-state-sensing algorithm), a driving-situation-sensing algorithm 320 (in one example, the element 320 may refer to a hardware device such as a circuit or a processor configured to execute the driving-situation-sensing algorithm), an inattention determiner 330, a driving complexity determiner 340, and a feedback determiner 350, for calculating an index of necessity of attention.

The driver-state-sensing algorithm 310 may be implemented to detect movement of the pupil, movement of the head of a driver, and the like, from an image of the driver, which is obtained through a camera for photographing an indoor area of the vehicle.

The inattention determiner 330 may determine the degree of inattention of the driver based on the movement of the pupil and the movement of the head of the driver, detected through the driver-state-sensing algorithm 310. The inattention determiner 330 may determine that the degree of inattention is lower as the movement of the pupil and the head of the driver is increased.

The driving-situation-sensing algorithm 320 may be implemented to detect a pedestrian, an external vehicle, a road sign, or the like, photographed using a camera for photographing an outdoor area of the vehicle.

The driving complexity determiner 340 may determine the driving complexity based on the sensing result of the driving-situation-sensing algorithm 320. The driving complexity determiner 340 may determine that driving complexity is higher as the number of surrounding vehicles and pedestrians is increased. When a sign is a go sign, the driving complexity is higher than in the case of a stop sign, and when the sign is a left-turn/right-turn sign, the driving complexity is higher than in the case of a straight sign.

The feedback determiner 350 may calculate the index of necessity of attention based on the degree of inattention of the driver and the driving complexity and may determine whether on/off of the feedback output 200 is controlled. When the degree of inattention is low and the driving complexity is also low, the feedback determiner 350 may output a feedback-on signal to the feedback output 200. As the feedback-on signal is applied, the feedback output 200 may provide an emotion-based service. In contrast, when the degree of inattention is high or the driving complexity is high, the feedback determiner 350 may output a feedback-off signal and may limit provision of the emotion-based service.

The aforementioned configuration for calculation of the index of necessity of attention may be embodied in the form of software, hardware, or a combination thereof in the controller 300, or some or all functions may also be performed by a component other than the controller 300.

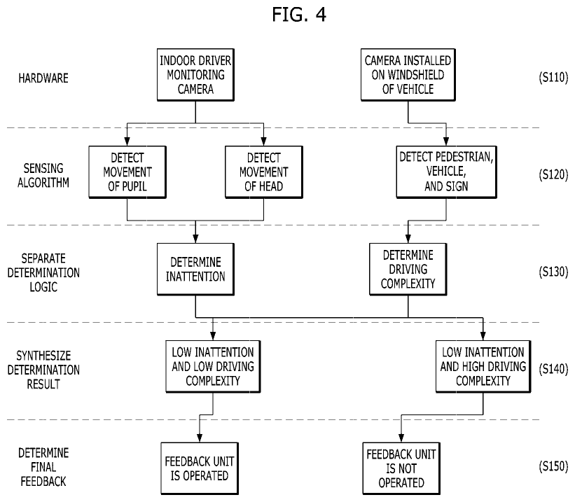

FIG. 4 is a diagram for explaining a method of calculating an index of necessity of attention according to an embodiment of the present disclosure.

Referring to FIG. 4, in order to calculate an index of necessity of attention, a camera at a hardware level may acquire an image (S110). A camera for photographing an indoor area of the vehicle may be an indoor driver monitoring camera for photographing the indoor area of the vehicle. A camera for photographing an outdoor area of the vehicle may be a camera installed on a windshield of the vehicle.

At the algorithm level, information required to calculate the index of necessity of attention may be sensed from the captured image (S120). The driver-state-sensing algorithm 310 may detect movement of the pupil and movement of the head of the driver. The driving-situation-sensing algorithm 320 may detect a pedestrian, an external vehicle, a road sign, or the like, photographed through a camera for photographing an outdoor area of the vehicle.

At a separate determination logic level, the degree of inattention and the driving complexity may be determined based on the information sensed at the algorithm level (S130). The inattention determiner 330 may determine that the degree of inattention is lower as the movement of the pupil and the head of the driver is increased based on degrees of the movement of the pupil and the head of the driver, detected through the driver-state-sensing algorithm 310. The driving-situation-sensing algorithm 320 may detect a pedestrian, an external vehicle, a road sign, or the like, photographed through a camera for photographing an outdoor area of the vehicle. The driving complexity determiner 340 may determine that driving complexity is higher as the number of surrounding vehicles and pedestrians is increased, according to the sensing result of the driving-situation-sensing algorithm 320.

At a level for synthesizing the determination result, the feedback determiner 350 may determine whether to transmit feedback based on the degree of inattention and the driving complexity (S140). When the degree of inattention is low and the driving complexity is also low, the feedback determiner 350 may output a feedback-on signal to the feedback output 200. When the degree of inattention is high or the driving complexity is high, the feedback determiner 350 may output a feedback-off signal.

According to the result of the determination as to whether to transmit feedback, the feedback output 200 may receive the feedback-on signal and may provide the emotion-based service (S150). When receiving the feedback-off signal, the feedback output 200 may not provide the emotion-based service.

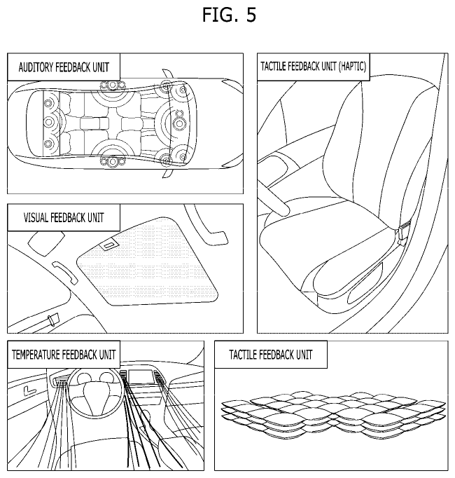

FIG. 5 is a diagram showing the configuration of the feedback output 200 according to an embodiment of the present disclosure.

The feedback output 200 may include at least one of the auditory feedback output 210, the visual feedback output 220, the tactile feedback output 230, or the temperature feedback output 240.

The auditory feedback output 210 may include a speaker installed in the vehicle. The auditory feedback output 210 may provide the emotion-based service by outputting sound such as music, a sound effect, a message, or white noise for improving the emotion of the user under the control of the controller 300.

The visual feedback output 220 may include a display, ambient lighting, or the like. The visual feedback output 220 may provide the emotion-based service by displaying an image for improving the emotion of the user or performing control to increase or reduce the intensity of illumination under the control of the controller 300.

The temperature feedback output 240 may include an air conditioning device. The temperature feedback output 240 may provide the emotion-based service by blowing cold or warm air to control the indoor temperature under the control of the controller 300.

The tactile feedback output 230 may include a vibration device installed on a seat, a tactile device installed on a steering wheel, or the like. The tactile feedback output 230 may provide the emotion-based service by outputting a vibration or outputting a tactile signal under the control of the controller 300.

As such, the controller 300 may provide the emotion-based service by controlling the auditory feedback output 210, the visual feedback output 220, the tactile feedback output 230, and the temperature feedback output 240, all of which correspond to the feedback output 200.

Here, if the controller 300 determines that specific emotion occurs or stress of a threshold value or greater occurs when controlling the feedback output 200, the controller 300 may determine whether to provide the service by calculating an index of necessity of attention required for driving from the eye movement of the user, sensed through an eye tracker, and information on the driving situation, acquired through an external camera.

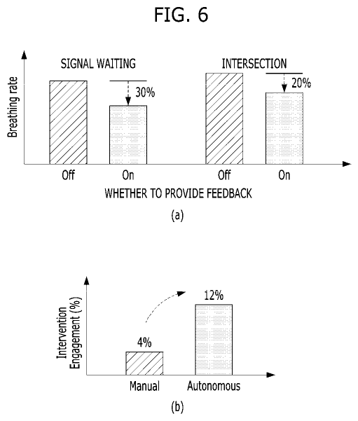

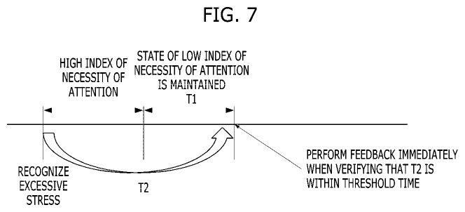

FIGS. 6 and 7 are diagrams for explaining a method of providing an emotion-based service based on an index of necessity of attention according to the present disclosure.

FIG. 6 is a graph showing characteristics whereby the effect of an emotion-based service is varied depending on the driving complexity and the degree of inattention.

(a) in FIG. 6 is a graph showing a change in a breathing rate when a vehicle waits at an intersection for a signal to change in the state in which an emotion-based service is provided.

It may be seen that, when the vehicle waits for a signal to change, if the emotion-based service is provided by turning on the feedback output 200, the breathing rate is improved by 30% compared with the case in which the feedback output 200 is turned off. In contrast, it may been seen that, when the vehicle travels at an intersection, if the emotion-based service is provided by turning on the feedback output 200, the breathing rate is improved by 20% compared with the case in which the feedback output 200 is turned off.

Because a driver needs to watch pedestrians, other vehicles entering an intersection, and so on while driving a vehicle through an intersection, driving complexity may be increased. In contrast, because the number of factors to which the driver needs to pay attention is relatively small when the driver waits for a traffic sign to change, the driving complexity may be reduced. That is, it may be seen that the effect of improving the breathing rate is reduced even if the emotion-based service is provided when the vehicle travels through an intersection having high driving complexity.

Accordingly, according to the present disclosure, when the driving complexity is equal to or greater than a reference value, the emotion-based service may not be provided.

(b) in FIG. 6 is a graph showing a change in intervention engagement when an emotion-based service is provided in a manual mode in which a user drives a vehicle, and an autonomous mode. The intervention engagement may be calculated by comparing a target emotional state (or a biological value) and an improved emotional state (or a biological value) by providing an emotion-based service.

As seen from the graph of FIG. 6B, intervention engagement of 4% is achieved in the manual mode, but intervention engagement of 12% is achieved in the autonomous mode. That is, it may be seen that the effect of the emotion-based service is remarkably improved in the autonomous mode, in which driving requires relatively little attention. Accordingly, according to the present disclosure, the emotion-based service may be provided in the autonomous mode irrespective of driving complexity and the degree of inattention.

FIG. 7 is a diagram for explaining a method of providing an emotion-based service depending on an index of necessity of attention according to an embodiment of the present disclosure.

Referring to FIG. 7, after excessive stress or a specific emotion that requires provision of an emotion-based service, in the state in which an index of necessity of attention equal to or greater than a reference value is maintained and provision of the emotion-based service is limited, the time during which the index of necessity of attention is maintained at a value for providing the emotion-based service may be counted. When the index of necessity of attention needs to be maintained at a predetermined value or less during a threshold time T1, and the time at which the maintenance of the index of necessity of attention is satisfied is within a threshold time T2, the emotion-based service may be maintained.

As described above, the time at which the emotion of the user occurs and the time at which the emotion-based service is provided may be different from each other and the service may be provided at a time appropriate for providing the service to the user, thereby improving satisfaction with the emotion-based service.

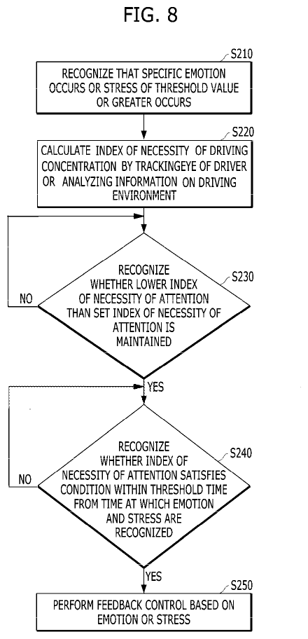

FIG. 8 is a control flowchart of a vehicle according to an embodiment of the present disclosure.

The controller 300 may determine whether the emotional state of the user is the state in which specific emotion occurs or whether stress of a threshold value or greater occurs, whereby an emotion-recognition-based service is required (S210).

Upon determining that the emotion-recognition-based service is required, the controller 300 may calculate an index of necessity of attention based on the state information and the driving state information of the user (S220).

The controller 300 may determine whether the state in which the index of necessity of attention is equal to or less than a reference value is maintained within a reference time (S230).

It may be determined whether the index of necessity of attention satisfies a condition of operation S230 within a reference time from the time at which the specific emotion occurs or stress of a threshold value or greater occurs (S240).

When the condition is determined to be satisfied, the feedback output 200 may be controlled to provide the emotion-recognition-based service (S250).

According to the aforementioned embodiments of the present disclosure, the emotion-recognition-based service may be performed in an environment in which attention of a user is not impeded in consideration of the attention that the user is paying to driving. In particular, the time at which the emotion of the user occurs and the time at which the emotion-based service is provided may be different from each other, and the service may be provided at a time appropriate for providing the service to the user, thereby improving satisfaction with the emotion-based service.

The vehicle and the method of controlling the same according to the at least one embodiment of the present disclosure as configured above may provide a service at a time appropriate for providing the service to a user in consideration of attention of the user.

In particular, the emotion-based service may be performed in an environment in which attention of the user is not impeded in consideration of the attention that the user is paying to driving, thereby improving satisfaction with the emotion-based service of the user.

It will be appreciated by persons skilled in the art that that the effects that could be achieved with the present disclosure are not limited to what has been particularly described hereinabove and other advantages of the present disclosure will be more clearly understood from the detailed description.

The aforementioned present disclosure can also be embodied as computer-readable code stored on a computer-readable recording medium. The computer-readable recording medium is any data storage device that can store data which can thereafter be read by a computer. Examples of the computer-readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc. The driver-state-sensing algorithm 310, the driving-situation-sensing algorithm 320, the inattention determiner 330, the driving complexity determiner 340, the feedback determiner 350, and the controller 300 each, or together, may be implemented as a computer, a processor, or a microprocessor. When the computer, the processor, or the microprocessor reads and executes the computer-readable code stored in the computer-readable recording medium, the computer, the processor, or the microprocessor may be configured to perform the above-described operations.

It will be apparent to those skilled in the art that various modifications and variations can be made in the present disclosure without departing from the spirit or scope of the embodiments. Thus, it is intended that the present disclosure cover the modifications and variations of the embodiment provided they come within the scope of the appended claims and their equivalents.

What is claimed is:

1. A method of controlling a vehicle, the method comprising:
acquiring biometric data of a user in the vehicle;
determining first determination information related to inattention of the user based on the biometric data;
acquiring driving related information of the vehicle;
determining second determination information related to driving complexity based on the driving related information; and
determining whether to provide a feedback function to the user based on the first determination information and the second determination information.

2. The method of claim 1, wherein the acquiring the biometric data comprises acquiring at least one of information on a face image, information on movement of a pupil, or information on movement of a head of the user.

3. The method of claim 2, wherein the determining the first determination information comprises determining a degree of inattention of the user based on at least one of the information on the movement of the pupil or the information on the movement of the head.

4. The method of claim 3, wherein the determining the first determination information comprises determining the degree of inattention to be higher as the movement of the pupil and the movement of the head are increased.

5. The method of claim 3, wherein the determining whether to provide the feedback function comprises determining not to provide the feedback function when the degree of inattention is equal to or greater than a reference value.

6. The method of claim 1, wherein the acquiring the driving related information of the vehicle comprises acquiring at least one of information on a road or information on a traffic situation based on information on an image of a region around the vehicle, information on a speed of the vehicle, or information on a position of the vehicle.

7. The method of claim 1, wherein the determining the second determination information comprises determining a value of the driving complexity based on at least one of the information on the road or the information on the traffic situation based on the information on the image of the region around the vehicle, the information on the speed of the vehicle, or the information on the position of the vehicle.

8. The method of claim 7, wherein the determining the second determination information comprises determining the value of the driving complexity to be higher as a number of vehicles and a number of pedestrians are increased, the vehicles and the pedestrians being recognized from the information on the image of the region around the vehicle.

9. The method of claim 7, wherein the determining the second determination information comprises determining the value of the driving complexity to be higher as the speed of the vehicle is increased.

10. The method of claim 7, wherein the determining the second determination information comprises determining the value of the driving complexity to be higher as a number of branch roads is increased in information on the road based on the information on the position of the vehicle.

11. The method of claim 7, wherein the determining whether to provide the feedback function comprises determining not to provide the feedback function when the value of the driving complexity is equal to or greater than a reference value.

12. The method of claim 1, further comprising:
in an autonomous mode, providing the feedback function irrespective of the first determination information and the second determination information.

13. The method of claim 1, wherein the determining whether to provide the feedback function to the user based on the first determination information and the second determination information comprises:
determining a degree of inattention of the user based on the biometric data;
determining a value of the driving complexity based on the driving related information;
calculating an index of necessity of attention, required when the user drives the vehicle, by synthesizing the degree of inattention and the value of the driving complexity; and
determining not to provide the feedback function when the index of necessity of attention is equal to or greater than a reference value.

14. The method of claim 13, further comprising:
providing the feedback function when a state in which the index of necessity of attention is less than the reference value is maintained during a first threshold time.

15. The method of claim 14, further comprising:
providing the feedback function when a time, at which the state in which the index of necessity of attention is less than the reference value is maintained during the first threshold time, is within a second threshold time.

16. The method of claim 1, wherein the feedback function comprises at least one of an auditory feedback function, a visual feedback function, a temperature feedback function, or a tactile feedback function, which is set depending on an emotional state or a stressed state determined based on the biometric data of the user.

17. A non-transitory computer-readable recording medium having recorded thereon a program for executing the method of claim 1.

18. A vehicle comprising:
a sensor configured to acquire biometric data of a user in the vehicle and driving related information of the vehicle;
a feedback output configured to output at least one feedback signal of auditory feedback, visual feedback, temperature feedback, or tactile feedback, which is set depending on an emotional state or a stressed state determined based on the biometric data of the user; and
a controller configured to determine first determination information related to inattention of the user based on the biometric data, to determine second determination information related to driving complexity based on the driving related information, and to perform control to determine whether the feedback output is operated based on the first determination information and the second determination information.

19. The vehicle of claim 18, wherein the controller determines a degree of inattention of the user based on movement of a pupil and movement of a head, included in the biometric data, determines a value of the driving complexity based on a number of pedestrians and a number of vehicles, included in the driving related information, calculates an index of necessity of attention, required when the user drives the vehicle, by synthesizing the degree of inattention and the value of the driving complexity, and determines not to provide the feedback function when the index of necessity of attention is equal to or greater than a reference value.
